(19) United States
(12) Patent Application Publication
(10) Pub. No.: US 2013/0299653 A1
(43) Pub. Date: Nov. 14, 2013

(54) Mounting System

(71) Applicants: Todd O. Emmons, SR., Hudson, FL (US); Teresa C. Emmons, Hudson, FL (US)

(72) Inventors: Todd O. Emmons, SR., Hudson, FL (US); Teresa C. Emmons, Hudson, FL (US)

(21) Appl. No.: 13/889,433

(22) Filed: May 8, 2013

Related U.S. Application Data
(60) Provisional application No. 61/644,279, filed on May 8, 2012.

(51) Int. Cl. F16M 13/02

(52) U.S. Cl. CPC F16M 13/02
USPC 248/205.3

(57) ABSTRACT

The mounting system comprises of a mounting assembly. The mounting assembly has a threaded cap and a provided threaded handle. The threaded cap is screwed onto the provided threaded handle, once screwed together it can be lifted to the desired surface for mounting. The threaded cap is attached to an adjustable arm also attached on the arm is an arm slot and a tab. The arm slot is provided to hold a hook with a magnet and the tap is used to mount a metal plate to surfaces that are non magnetic.

### CROSS-REFERENCE TO RELATED APPLICATION

This application claims the benefit of provisional patent application Ser. No. 61/644,279, 2012 May 8 by the present inventor.

### BACKGROUND-PRIOR ART

The following is a tabulation of some prior art that presently appears relevant:

U.S. Patents

| Pat. No. | Kind Code | Issue Date | Patentee |
|---|---|---|---|
| 4,851,977 | A | 1989-07-25 | Gary |
| 5,142,461 | A | 1992-08-25 | Nugent |
| 5,188,332 | A | 1993-02-23 | Callas |
| 5,388,802 | A | 1995-02-14 | Dougan et al. |
| 5,609,415 | A | 1997-03-11 | Protz, Jr. |
| 6,491,271 | B1 | 2002-12-10 | Adams |
| 7,549,779 | B2 | 2009-06-23 | Genenbacher |

U.S. Patent Application Publications

| Publication Number | Kind Code | Publication Date | Applicant |
|---|---|---|---|
| 20060138293 | A1 | 2006-06-29 | Clement |

### DESCRIPTION OF THE PRIOR ART

The use of systems to support strings of lights is well known in the prior art. More specifically, mounting systems of known designs and configurations previously devised and utilized for this purpose, through known methods and apparatuses are known to consist basically of familiar, expected, and obvious structural configuration, notwithstanding, the myriad of designs encompassed by the crowded prior art which has been developed for the fulfillment of countless objectives and requirements.

By way of example, U.S. Pat. No. 4,851,977 issued Jul. 25, 1989 to Gary related to a Bracket for Decorative Lighting. U.S. Pat. No. 5,142,461 issued Aug. 25, 1992 to

Nugent related to a Decorative Light Mounting Apparatus and Method. U.S. Pat. No. 5,188,332 issued Feb. 23, 1993 to Callas related to a Sign Holder, U.S. Pat. No. 5,388,802 issued Feb. 14, 1995 to Dougan related to a Method and Apparatus for Suspending Christmas Lights Underneath Eaves on a House, U.S. Pat. No. 5,609,415 issued Mar. 11, 1997 to Protz, Jr. for a Light Clip for Shingles or Gutters, U.S. Pat. No. 6,491,271 issued Dec. 10, 2002 to Adams for a Magnetic Hook or Clip, Lastly U.S. Pat. No. 7,549,779 issued Jun. 23, 2009 to Genenbacher for a Magnetic Light Fixture, U.S. Pat. Application No. 20060138293 Publication Date Jun. 29, 2006 to Clement for a Remotely positionable and magnetically attachable securement device.

While these devices fulfill their respective, particular objectives and requirements, the aforementioned patents do not describe a mounting system that allows strings of lights to be mounted to any surface by way of a mounting assembly with adhesive metal plates and magnetic hooks.

In this respect, the mounting system according to the present invention substantially departs from the conventional concepts and designs of the prior art, and in doing so provides an apparatus primarily developed for the, purpose of mounting string of lights and a variety other objects onto any surface.

Therefore, it can be appreciated that there exists a continuing need for a new and improved mounting system which can be used for mounting strings of lights and a variety of other objects onto any surface.

### SUMMARY

In view of the foregoing disadvantages inherent in the known types of mounting systems of known designs and configurations now present in the prior art, the present invention provides an improved mounting system. As such, the general purpose of the present invention, which will be described subsequently in greater detail, is to provide a new and improved mounting system and method which has all the advantages of the prior art and none of the disadvantages.

To attain this, the present invention essentially comprises a mounting system. First provided is a mounting assembly. The mounting assembly has a threaded cap. A threaded mounting handle is provided. The threaded cap is screwed onto the provided threaded mounting handle. The threaded cap has an adjustable nut. The threaded cap has a bolt. The threaded cap has an arm. The threaded cap arm has a tab. The threaded cap arm has an arm slot.

Further provided are metal plates, the metal plates have adhesive on one side. The metal plates have a hole provided.

Provided next are hooks that have a provided magnet, which is inserted into a casing as part of the mounting system.

There has thus been outlined, rather broadly, the more important features of the embodiment of the mounting system in order that the detailed description thereof that follows may be better understood and in order that the present contribution to the art may be better appreciated. There are, of course, additional features of the embodiment to the mounting system that will be described hereinafter and which will form the subject matter of the claims attached.

In this respect, before explaining a least one embodiment of the invention in detail, it is to be understood that the embodiment of the mounting system is not limited in its application to the details of construction and to the arrangements of the components set forth in the following description or illustrated in the drawings. The mounting system is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for designing of other structures, methods and systems for carrying out several purposes of the present invention. It is important, therefore, that the claims be regarded as including such equivalent construction insofar as they do not depart from the spirit and scope of the embodiments of the mounting system.

It is therefore an object of the embodiment of my mounting system is to provide a new and improved mounting system which has all of the advantages of the prior art mounting systems of known designs and configurations and none of the disadvantages.

It is another object of the embodiment of my mounting system is to provide a new and improved mounting system which has all of the advantages of the prior art mounting system which may be easily efficiently manufactured and marketed.

It is a further object of the embodiment of my mounting system is to provide a new and improved mounting system which is of durable and reliable constructions.

An even further object of the embodiment of my mounting system is to provide a new and improved mounting system which is susceptible of a low cost to manufacture with regard to both materials and labor, and which accordingly is then susceptible of low prices of sale to the consuming public, thereby making such mounting system economically available to the buying public

Even still another object of the embodiment of my mounting system is to provide a new and improved mounting system.

The mounting assembly has a threaded cap attached to the threaded cap is an arm byway of a bolt and nut this allows the arm to be adjusted to different angles. The threaded cap has an arm the arm has a tab. The metal plate has a hole. The tab holds the metal plate. The metal plate is lifted by way of the mounting assembly arm to the desired mounting surface and adhered byway of the adhesive or can be mounted byway of a screw or a nail.

The hooks with the provided magnets in the casing are used to attach a string of lights or a variety of objects. The hooks with the provided magnets in the casing are slide onto the mounting assembly arm slot then is raised to the desired mounting surface. The metal plates allow the magnetic hooks to be mounted to any non magnetic surface.

These together with other objects to the embodiments of the mounting system, along with the various features of novelty which characterize the invention, are pointed out with particularity in the claims annexed to and forming a part of this disclosure. For a better understanding of the embodiments of my mounting system its operation advantages and the descriptive matter in which there is illustrated embodiments of my mounting system.

### BRIEF DESCRIPTION OF THE DRAWINGS

The embodiments of my mounting system will be better understood and advantages other than those set forth above will become apparent when consideration is given to the following detailed description thereof. Such description makes reference to annexed drawing wherein:

FIG. 1 is an upward perspective view of a mounting system with the one embodiment.

FIG. 2 is a perspective sideward view of the mounting assembly with one embodiment.

FIG. 3 is a side view of the mounting system with an additional embodiment.

FIG. 4 is a side view of the hook with an alternate embodiment.

### DETAILED DESCRIPTION OF DRAWINGS

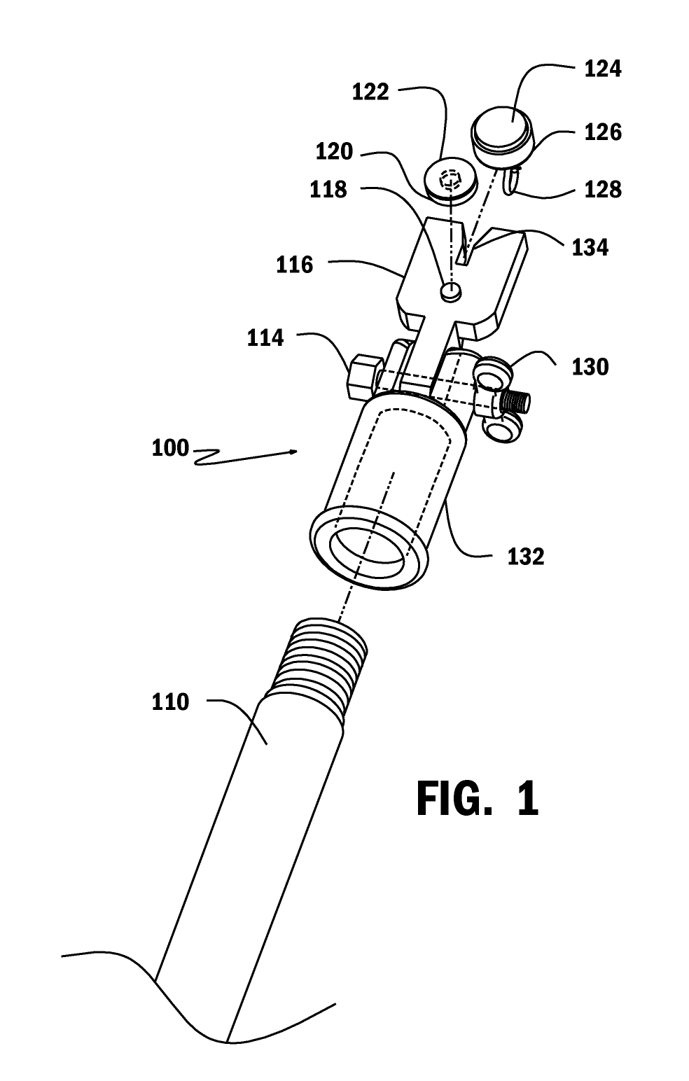

FIG. 1 is an upward perspective view of a mounting system. Provided is a threaded mounting handle 110 and also provided is a magnet 124. Comprising first of a mounting assembly 100 in accordance with at least one embodiment. A threaded cap 132 screws onto the provided threaded mounting handle 110. An arm 116 is connected to the threaded cap 132 by a bolt 114 and a nut 130. The arm 116 has a tab 118 and an arm slot 134. A metal plate 120 has an adhesive 122 applied to the top side. A hook 128 has the provided magnet 124 inserted into a casing 126. The mounting assembly 100 can be formed in a variety of shapes such as circular, square, triangle e.g., and can be manufactured with various composite material such as polyethylene, PVC (vinyl), wood and the like. The metal plate 120 can be formed in a variety of shapes such as circular, square, triangle, e.g. and can be manufactured with different feral magnetic materials.

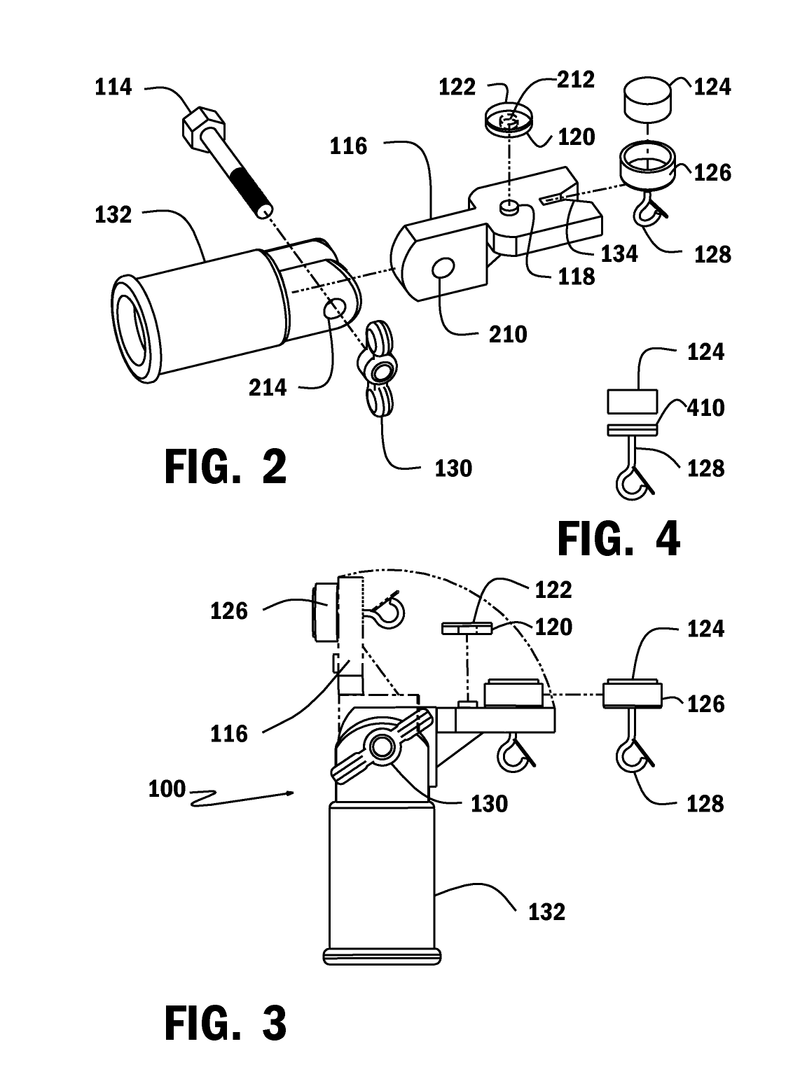

FIG. 2 is a perspective sideward view of the mounting assembly 100. A hole 214 in the threaded cap 132 and the arm 116 showing a hole 210 so as to connect the arm 116 and the threaded cap 132 together by way of the bolt 114 sliding through the holes 210 and 214 and fastening them tightly together with the nut 130. The metal plate 120 has a hole 212 for placement on top of the tab 118. The hook 128 casing 126 and the provided magnet 124 can be slide into the arm slot 134.

FIG. 3 The mounting assembly 100 arm 116 is shown in a vertical position and a horizontal position. The arm 116 is adjustable into any angle by the nut 130 to allow ease of mounting.

FIG. 4 is a side view of the hook 128 as an alternate embodiment. The hook 128 can be mounted to the provided magnet 124 by adhesive 410. The hook 128 can take on any shape or size and can be manufactured as a clip, clamp, push in slot or the like.

### DRAWINGS

### Reference Numerals

| | | | |
|---|---|---|---|
| 100 | Mounting assembly | 116 | Arm |
| 110 | Threaded mounting | 118 | Tab |
| | handle | 120 | Metal Plate |
| 114 | Bolt | 122 | Adhesive |
| 124 | Magnet | 134 | Arm Slot |
| 126 | Casing | 210 | Hole |
| 128 | Hook | 212 | Hole |
| 130 | Nut | 214 | Hole |
| 132 | Threaded Cap | 410 | Adhesive |

### Operation

In operation one uses the mounting assembly 100 and any provided threaded mounting handle 110 or extension handle as a tool to place strings of lights onto eaves, under soffits, onto gutters of houses, screen enclosures, boats, cars, trees, trucks, office buildings e.g. Also, it can be used in hanging any home décor, wind chimes, plants on porches and other various items. (FIG. 1)

(1) When the mounting system is assembled, one would take the metal plate 120 that has the adhesive 122 on the top side and place it on the arm 116 tab 118. (FIGS. 1, 2 and 3). Adjust the arm 116 to apply to any surface. (FIG. 3) Raise the assembled mounting system to the face or underside of the fascia or soffit or any other surface and apply pressure to the surface to allow the tab 118 adhesive 122 to stick. Keep applying the tabs 118 until you have reached your desired placement for the lights or objects that you want to hang.

(2) Then fasten the hook 128 that has the magnet 124 attach to the light string or object. Place the hook 128 and magnet 124 into the arm slot 134. Using the assembled mounting system (FIG. 1) Raise it up to the metal plate 120 that was placed on the surface prior or any magnetic surface. Repeat this until desired lights or objects are hung. To remove pull down on the string of lights or object to detach the magnet 124 hooks 128 from the metal plates 120.

(3) The hole, 212 in the metal plate 120 can alternatively be mounted with a screw or nail.

(4) The hook 128 can be mounted to the provided magnet 124 with adhesive 410 or slide into the casing 126. The hook 128 also can be of any shape or size.

(5) The provided magnet 124 and hook 128 can attach to any magnetic surface. This would be an alternative to the metal plate 120.

I claim:

1. A mounting system comprising:
a mounting assembly used as a means for mounting objects to surfaces byway of a metal plate and a hook along with a magnet connected to said hook, first provided is the said mounting assembly, connected to said mounting assembly is a threaded cap, the said threaded cap uses a threaded mounting handle, a arm is attached to said threaded cap, the said arm and the said threaded cap are connected with a bolt and a nut, thereby allowing the said arm on the said threaded cap to be adjusted and;
the said arm has a arm slot, and the said arm has a tab thereby allowing the said hook along with the said magnet to slide into the said arm slot and said metal plate to rest on said tap for mounting to any surface and;
the said metal plate has a hole for means for connecting to said tab onto said arm and said metal plate has a adhesive on one side thereby retaining the means to connect the said metal plate to any surface byway of the said mounting assembly and;
the said hook has a means of attaching the said magnet into a casing, thereby the said hook and said magnet attached as one.

2. The mounting system as set forth in claim 1 in which said mounting assembly material can be constructed of, plastic, vinyl, polyethylene or like composite.

3. The mounting system as set forth in claim 1 whereby the mounting assembly can be manufactured in a variety of shapes such as round or square.

4. The mounting system as set forth in claim 1 that the said metal plate material that is conducive for a magnet to attach to or the like.

5. The mounting system as set forth in claim 4 whereby the said metal plate can be manufacture in a variety of shapes such as round or square.

6. The mounting system as set forth in claim 5 wherein the said metal plate can be constructed solid.

7. The mounting system as set fourth in claim 6 in which the said metal plate can be mounted byway of a nail, screw or the like.

8. The mounting system as set fourth in claim 1 wherein the said magnet can be mounted to said hook byway of adhesive or the like.

9. The mounting system as set fourth in claim 8 and the said magnet can be mounted into and manufactured into any shape such as a clip or the like.

10. The mounting system as set fourth in claim 1 in which the said casing for the said hook can be constructed out of any material such as, plastic, vinyl, polyethylene, metal or like composite.
